(19) United States
(12) Patent Application Publication
(10) Pub. No.: US 2022/0051386 A1
(43) Pub. Date: Feb. 17, 2022

(54) IMAGE INSPECTING APPARATUS, IMAGE INSPECTING METHOD, AND COMPUTER-READABLE RECORDING MEDIUM STORING IMAGE INSPECTING PROGRAM

(71) Applicant: Konica Minolta, Inc., Tokyo (JP)

(72) Inventor: Shinichi ASAI, Tokyo (JP)

(73) Assignee: Konica Minolta, Inc., Tokyo (JP)

(21) Appl. No.: 17/392,359

(22) Filed: Aug. 3, 2021

(30) Foreign Application Priority Data
Aug. 13, 2020 (JP) 2020-136779

(51) Int. Cl. G06T 7/00; G06T 5/00; G06T 5/50

(52) U.S. Cl. CPC G06T 7/0002; G06T 5/002; G06T 2207/10024; G06T 2207/20024; G06T 2207/20224; G06T 5/50

(57) ABSTRACT

An image inspecting apparatus may include an image analyzer that may: calculate difference data of each image data obtained by performing smoothing processing for image data with multiple smoothing filters different in range; extract multiple abnormal candidates on a basis of the difference data; make a range in which the multiple extracted abnormal candidates are collected, as a target region; and detect one abnormal candidate as an abnormality from the multiple abnormal candidates included in the target region on a basis of the difference data.

### CROSS-REFERENCE TO RELATED APPLICATIONS

This application claims priority to Japanese Patent Application No. 2020-136779, filed on Aug. 13, 2020, the entire disclosure of which being incorporated herein by reference in its entirety.

### BACKGROUND

### Technical Field

The present disclosure relates to an image inspecting apparatus, an image inspecting method, and a computer-readable recording medium storing an image inspecting program.

### Description of Related Art

In printed matters on which images are formed by an electrophotographic system, there may be a case where image abnormalities occur. As an example of the image abnormalities of the printed matters, there is a spot-shaped (dot-shaped) abnormality.

On the other hand, at the time of forming an image by the electrophotographic system, there may be a case where spot-shaped abnormalities being not in original image data occur. This spot-shaped abnormality is referred to as a firefly. On image printed matters, fireflies appear as pale undulations. In particular, in halftone image printed matters, fireflies are easy to detect by people's eyes, resulting in that the quality of the printed matters is lowered.

Conventionally, as techniques for detecting the abnormalities of images on printed matters, for example, there is a technique disclosed by Patent Literature 1 (JP 1995-186375A). In Patent Literature 1, a normal image is subjected to filter processing by using a minimum value filter and/or maximum value filter, thereby forming a standard image. Successively, an inspection image is compared with this standard image, thereby acquiring differential values. Successively, these differential values are compared with an allowable value (threshold), thereby detecting abnormalities of an image.

### SUMMARY

In the conventional technique, the gradation values of pixels of an inspection image are compared with the gradation values of pixels after the filter processing. For this reason, with the conventional technique, in the case where there are large abnormalities, the difference values with the reverse sign may appear in close proximity to that abnormal pixel. In the case where such the difference values with the reverse sign appear, in the conventional technique, even in the case where they are not abnormal, they might have been falsely detected as abnormalities.

Then, an object of the present disclosure may be to provide an image inspecting apparatus, image inspecting method, and image inspecting program that improves inspection accuracy of an image.

The above-described object of the present disclosure can be attained by the following configurations. In order to realize the above-described object, an image inspecting apparatus that reflects one aspect of the present disclosure, includes a calculator that calculates difference data of each image data obtained by performing smoothing processing for image data with multiple smoothing filters different in range; an extractor that extracts multiple abnormal candidate on a basis of the difference data; and a detector that makes a range in which the extracted multiple abnormal candidates are collected, into a target region and detects one abnormal candidate as an abnormality from the multiple abnormal candidates included in the target region on a basis of the difference data.

In order to realize the above-described object, an image inspecting method that may reflect one aspect of the present disclosure, includes (a) calculating difference data of each image data obtained by performing smoothing processing for image data with multiple smoothing filters different in range; (b) extracting multiple abnormal candidates on a basis of the difference data; and (c) making a range in which the extracted multiple abnormal candidates are collected, into a target region and detecting one abnormal candidate as an abnormality from the multiple abnormal candidates included in the target region on a basis of the difference data.

### BRIEF DESCRIPTION OF THE DRAWINGS

The advantages and features provided by one or more embodiments of the disclosure will become more fully understood from the detailed description given hereinbelow and the appended drawings which are given by way of illustration only, and thus are not intended as a definition of the limits of the present disclosure.

FIG. 1 is a drawing showing a schematic configuration of an image forming system including an image inspecting apparatus according to one embodiment.

FIG. 2 is a block diagram showing a hardware configuration of the image forming system.

FIG. 3 is a plan view for describing a first smoothing filter.

FIG. 4 is a plan view for describing a second smoothing filter.

FIG. 5 is a graph showing gradation values after processing by two kinds of smoothing filters.

FIG. 6 is a graph showing difference data after smoothing processing by the first smoothing filter and the second smoothing filter for read image data having a firefly.

FIGS. 7A, 7B, 7C, and 7D are plan views for describing a pixel having a firefly and its peripheral pixels.

FIG. 8 is a graph in which a gradation value of each pixel is made an absolute value.

FIG. 9 is a flowchart showing a procedure of image inspecting processing by an inspecting apparatus.

### DETAILED DESCRIPTION OF EMBODIMENTS

Hereinafter, with reference to the drawings, embodiments of the present disclosure will be described in detail. However, the scope of the disclosure is not limited to the disclosed embodiments. In this connection, in the description for the drawings, the same constitutional element is provided with the same reference symbol, and the overlapping description is omitted. Moreover, dimensional ratios in the drawings are exaggerated on account of description and may be different from the actual ratios.

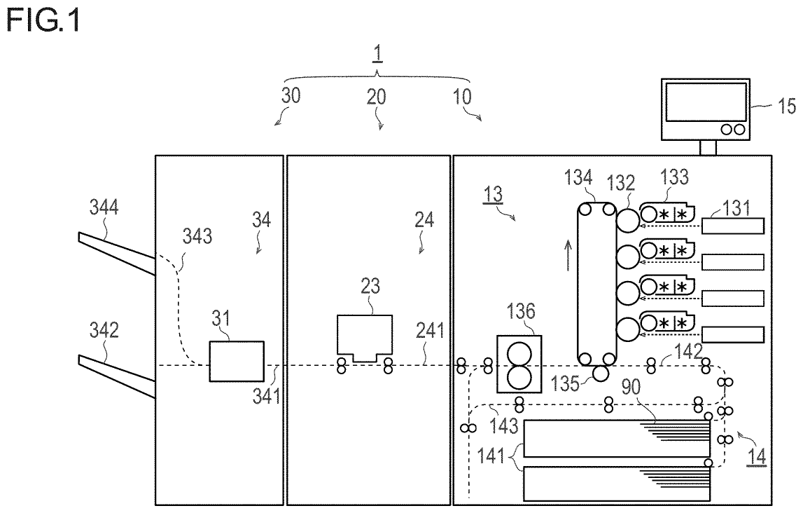

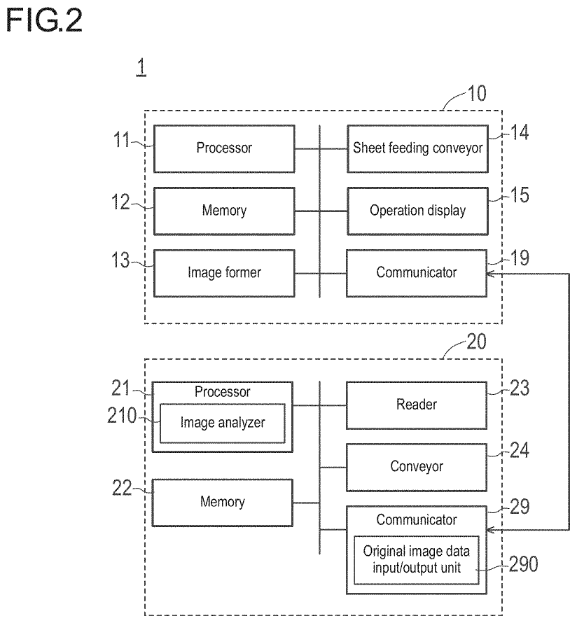

FIG. 1 is a drawing showing a schematic configuration of an image forming system including an image inspecting apparatus according to one embodiment of the present disclosure. FIG. 2 is a block diagram showing a hardware configuration of the image forming system.

As shown in FIGS. 1 and 2, an image forming system 1 includes an image forming apparatus 10, an image inspecting apparatus 20, and a post processing apparatus 30.

The image forming apparatus 10 forms images on sheets 90 (recording material) on the basis of original image data (also, referred to as print data).

The image inspecting apparatus 20 includes a reader 23, reads an image on a sheet 90 printed by the image forming apparatus 10, and generates read image data. Moreover, the image inspecting apparatus 20 performs inspection for an image density, color, and an image formation position on the basis of the generated read image data, thereby detecting abnormalities and performing various kinds of image adjustments, such as density adjustment, color adjustment, and position deviation adjustment.

The post processing apparatus 30 performs various kinds of post-processing for sheets printed by the image forming apparatus 10.

In this connection, in the following embodiment, as shown in FIG. 1, although the image inspecting apparatus 20 is described as being a separate body connected to the image forming apparatus 10, the image inspecting apparatus 20 may share a housing with the image forming apparatus 10 and may be configured as one body. Moreover, in the following description, the image inspecting apparatus 20 is located on the downstream side of the image forming apparatus 10 in the conveyance direction of a sheet 90 and is described as performing inspection in real time for a sheet 90 on which an image has been formed in the image forming apparatus 10. However, the image inspecting apparatus 20 may be configured to be a separate body from the image forming apparatus 10 and to be connected with a network in terms of communication. Moreover, the image inspecting apparatus 20 may be configured to perform inspection for an image by acquiring read image data and original image data corresponding to the read image data through off-line. In this case, a reader (below-mentioned reader 23) may be disposed within a conveyance passage so as to read a sheet 90 being conveyed in the inside of the image forming apparatus 10.

### (Image Forming Apparatus 10)

As shown in FIG. 2, the image forming apparatus 10 includes a processor 11, a memory 12, an image former 13, a sheet feeding conveyor 14, an operation display 15, and a communicator 19, and these components are mutually connected through a bus for exchanging signals.

### (Processor 11, Memory 12)

The processor 11 is a CPU (Central Processing Unit) and performs control for each unit of an apparatus and various kinds of arithmetic processing in accordance with a program. The memory 12 includes a ROM (Read Only Memory) that stores various programs and the various kinds of data beforehand, a RAM that memorizes a program and data temporarily as a work area, a hard disk that stores various programs and various kinds of data, and so on. Such the configurations of the processor 11 and the memory 12 are similar to those of a computer.

### (Image Former 13)

The image former 13 forms an image, for example, by an electrophotographic system and includes writers 131 and image creators corresponding to respective basic colors (YMCK). Each image creator includes a photoconductor drum 132, a charging electrode (not shown), a development unit 133 that stores a two-component developer composed of toner and carrier, and a cleaner (not shown). Toner images formed by the respective image creators corresponding to the basic colors (YMCK) are superimposed on each other on an intermediate transfer belt 134 and are transferred onto a conveyed sheet 90 in a secondary transferor 135. The toner images (of full color) on the sheet 90 are fixed on the sheet 90 by being heated and pressurized in a fixer 136 on the downstream side.

### (Sheet Feeding Conveyor 14)

The sheet feeding conveyor 14 includes a plurality of sheet feeding trays 141, conveyance paths 142 and 143, a plurality of conveyance rollers disposed on these conveyance paths 142 and 143, and a drive motor (not shown) that drives these conveyance rollers. A sheet 90 fed out from the sheet feeding tray 141 is conveyed on the conveyance path 142, subjected to image formation in the image former 13, and, thereafter, sent to the image inspecting apparatus 20 on the downstream side.

Moreover, in the case where the printing setting of a print job is the setting of double-side printing, a sheet 90 that has been subjected to image formation on its one side surface (first surface), is conveyed to an ADU conveyance path 143 disposed at a lower part of the image forming apparatus 10 by the sheet feeding conveyor 14. The sheet 90 conveyed to this ADU conveyance path 143 is turned upside down on a switchback path, thereafter, joins the conveyance path 142, and is subjected again to image formation on the other side (second side) of the sheet 90 in the image former 13.

### (Operation Display 15)

The operation display 15 includes a touch panel, a ten key, a start button, a stop button, and the like, displays a state of the image forming system 1, and is used for various kinds of settings and the input of an instruction by a user. Moreover, the operation display 15 receives the execution instruction of below-mentioned color adjustment and image position adjustment by a user. Moreover, in the case where abnormalities have been determined in inspection by the image inspecting apparatus 20, the operation display 15 displays an analysis result.

### (Communicator 19)

The communicator 19 is an interface through which the image forming apparatus 10 communicates with the image inspecting apparatus 20, the post processing apparatus 30, and external devices, such as a PC. The communicator 19 transmits and receives various setting values, various kinds of information required for an operation timing control, and the like between itself and the image inspecting apparatuses 20. Furthermore, the communicator 19 receives a print job from an external device.

In the communicator 19, various local connecting interfaces, such as network interfaces based on standards, such as SATA, PCI, USB, Ethernet (registered trademark), and IEEE1394 and wireless communication interfaces, such as a such as Bluetooth (registered trademark) and IEEE802.11, are used.

### (Image Inspecting Apparatus 20)

As shown in FIGS. 1 and 2, the image inspecting apparatus 20 includes a processor 21, a memory 22, a reader 23, a conveyor 24, and a communicator 29. These components are mutually connected through signal lines, such as a bus for exchanging a signal.

The processor 21 and the memory 22 include the respective similar configurations of the above-mentioned processor 11 and memory 12. This processor 21 performs image adjustment, image inspection, and the like of the image forming system 1 by cooperating with the processor 11 of the image forming apparatus 10.

### (Processor 21, Memory 22)

The processor 21 functions as an image analyzer 210. The processor 21 is a CPU and performs control for each unit of the apparatus and various kinds of arithmetic processing. In particular, the processor 21 executes the functions of the image analyzer by executing an image inspecting program. The memory 22 includes a ROM that stores an image inspecting program and various kinds of data beforehand, a RAM that memorizes a program and data temporarily as a work area, a hard disk that stores various kinds of programs and various kinds of data, and so on. In particular, the memory 22 memorizes original image data, read image data, and so on. Such the configurations of the processor 21 and the memory 22 are similar to those of the computer.

### (Reader 23)

The reader 23 is disposed on the conveyance path 241 and reads an image on a sheet 90 that has been subjected to image formation in the image forming apparatus 10 and then conveyed. In this connection, so as to be able to read both surfaces simultaneously (one pass), the same reader may be disposed also below the conveyance path 241. Alternatively, a conveyance path similar to the ADU conveyance path 143 of the image forming apparatus 10 is disposed such that both surfaces are read by one reader 23.

The reader 23 includes a sensor array, a lens optical system, an LED (Light Emitting Diode) light source, and a housing that store these components. The sensor array is a color line sensor (for example, a CCD (Charge Coupled Device) image sensor, a CMOS (Complementary Metal Oxide Semiconductor) image sensor, and so on) in which a plurality of optical elements is arranged in a line shape along a main scanning direction, and its reading region in a width direction corresponds to the full width of a sheet 90. An optical system includes a plurality of mirrors and lenses. Light from the LED light source penetrates an original document glass and irradiates the surface of a sheet 90 that passes a reading position on the conveyance path 241. Image light by surface-reflected light on this reading position is led by an optical system and is formed as an image on a sensor array. The resolution of the reader 23 is 100 to hundreds dpi.

### (Conveyor 24)

The conveyor 24 includes a conveyance path 241, a plurality of conveyance rollers disposed on this conveyance path 241, and a drive motor (not shown) that drives these conveyance rollers. The conveyance path 241 is connected with the conveyance path 142 disposed on the upstream side, receives a sheet 90 on which an image has been formed in the image forming apparatus 10, and sends the sheet 90 to the post processing apparatus 30 disposed on the downstream side.

### (Communicator 29)

The communicator 29 functions as an original image data input/output unit 290. The communicator 29 performs transmitting and receiving various kinds of setting values and various kinds of information necessary for operation timing control between itself and the communicator 19 of the image forming apparatus 10. Then, the communicator 29 receives original image data included in a print job from the communicator 19 of the image forming apparatus 10 by the control of the processor 21. The communicator 29 memorizes the received original image data in the memory 22. The communicator 29 includes a local connection interface necessary for communicating with the communicator 19.

### (Post Processing Apparatus 30)

The post processing apparatus 30 includes a post processor 31 and a conveyor 34 as shown in FIG. 1. The conveyor 34 includes conveyance paths 341 and 343, a plurality of conveyance rollers disposed on these conveyance paths 341 and 343, and a drive motor (not shown) that drives these conveyance rollers. Moreover, the post processing apparatus 30 includes sheet delivery trays 342 and 344. In this connection, although illustration is omitted, similarly to other apparatuses shown in FIG. 2, the post processing apparatus 30 includes a processor, a memory, and a communicator, and by cooperating with other apparatuses, the post processing apparatus 30 performs processing for a sheet 90.

The conveyance path 341 is connected to the conveyance path 241 disposed on the upstream side and receives a sheet 90 conveyed from the image inspecting apparatus 20. Then, the post processing apparatus 30 performs the post processing according to printing setting for the sheet 90, and thereafter, discharges it to the sheet delivery tray 342. Moreover, the post processing apparatus 30 discharges the conveyed sheet 90 in accordance with the printing setting to the sheet delivery tray 344 via the conveyance path 343. Moreover, the post processing apparatus 30 may discharge a sheet 90 determined as normal in the later-mentioned inspection to an ordinary sheet delivery tray 342 and discharge a sheet 90 determined as abnormal to another sheet delivery tray 344.

The post processor 31 performs various kinds of post-processing, such as staple processing, punch processing, and booklet formation processing. For example, the post processor 31 includes a stacker that stacks sheets and a stapler, superimposes a plurality of sheets 90 in the stacker, and, thereafter, performs flat stitching processing by using staples in the stapler.

### (Image Inspection)

Image inspecting processing is processing that detects abnormalities of an image printed on a sheet 90 by the image forming apparatus 10. The processor 21 of the image inspecting apparatus 20 performs the image inspecting processing as a function of the image analyzer 210.

The image analyzer 210 functions as a calculator that calculates difference data of each of image data that have been subjected to smoothing processing with smoothing filters with respective ranges differ for image data. Moreover, the image analyzer 210 functions as an extractor that extracts an abnormal candidate on the basis of the difference data. Moreover, the image analyzer 210 functions as a detector that collects a plurality of extracted abnormal candidates in a range, makes the range a target region, and detects one abnormal candidate as abnormalities, on the basis of the difference data, from the plurality of abnormal candidates included in the target region.

In the image inspecting processing, first, the processor 11 of the image forming apparatus 10 becomes a main member and performs printing an image onto a sheet and conveying the printed sheet to the image inspecting apparatus 20. Successively, the processor 21 of the image inspecting apparatus 20 makes the reader 23 read an image from the printed sheet conveyed to the reader 23.

In the present embodiment, the image inspecting processing is described on a basis of an example of a case where a firefly (also, referred to as a white void and a white spot) being one of abnormalities within an image is made a detection target. The term “firefly” used in here is a phenomenon that a part of an image after transfer turns to white (an image density becomes thin) in a circular shape due to the following reasons. That is, for example, carrier particles in a development unit 133 adhere to an intermediate transfer belt 134 via a photoconductor drum 132, and the carrier particles become foreign substances at the time of secondary transfer. Then, the carrier particles make the adhesion between a sheet 90 and the intermediate transfer belt 134 insufficient in their periphery, resulting in the part of an image after transfer turns to white. For this reason, in many cases, fireflies appear as white-spot-shaped pixels in a color image. A color image means, for example, an image colored with colors other than the ground color of a sheet and includes an image of a single color of black. In particular, fireflies tend to become more noticeable in so-called halftone image with uniform intermediate image densities.

Although a processing procedure will be mentioned later, in image inspecting processing, first, original image data to be used for printing is acquired from a print job, and further, read image data is generated by reading a sheet 90 after printing.

Successively, in the image inspecting processing, for each of the original image data and the read image data, smoothing processing is performed with smoothing filters different in processing range. The smoothing filters includes a first smoothing filter and a second smoothing filter.

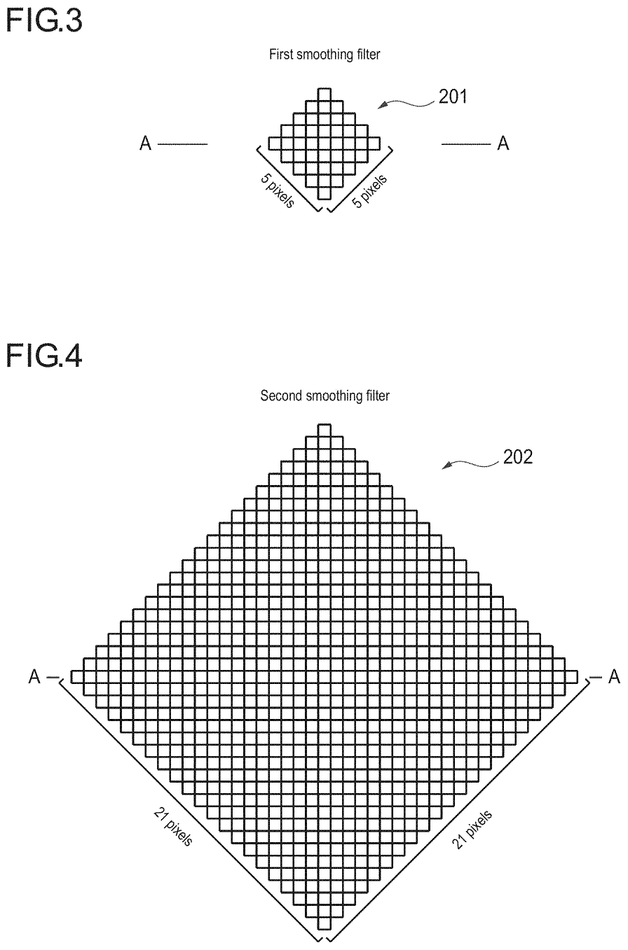

FIG. 3 is a plan view for describing the first smoothing filter. FIG. 4 is a plan view for describing the second smoothing filter.

A range for which the first smoothing filter 201 performs the smoothing processing is a first region. A range for which the second smoothing filter 202 performs the smoothing processing is a second region. The first smoothing filter 201 shown in FIG. 3 performs the smoothing processing for a rectangular range (first region) of 5×5 pixels. On the other hand, the second smoothing filter 202 shown in FIG. 4 performs the smoothing processing for a rectangular range (second region) of 21×21 pixels.

The first smoothing filter 201 is a small-area smoothing filter for eliminating high frequency components (noise). For example, it calculates average gradation. The second smoothing filter 202 is a large-area smoothing filter for calculating average gradation of a background.

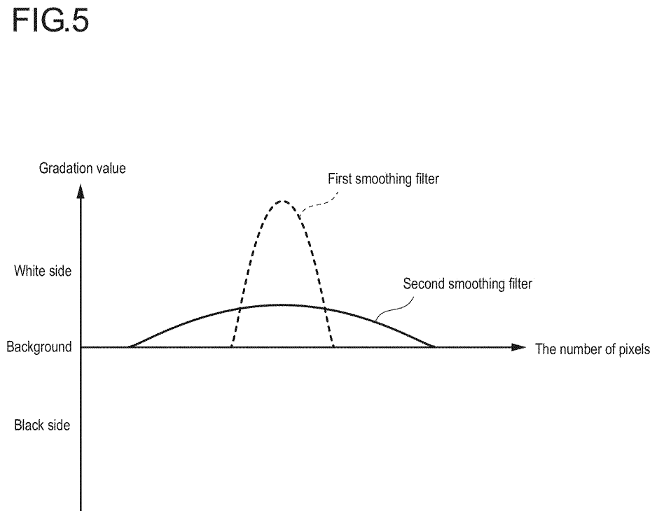

FIG. 5 is a graph showing gradation values after processing by two kinds of smoothing filters. In the graph in FIG. 5, pixels in the A-A line direction of each smoothing filter described in FIGS. 3 and 4 are defined along a horizontal axis, and gradation values are defined along a vertical axis. The gradation value of a pixel is set to become higher as the pixel becomes whiter. Moreover, this graph shows an example in which a firefly (abnormality) is located almost at a center of each smoothing filter in the read image data.

As shown in FIG. 5, in the case where there is a firefly, the graph of each of the first smoothing filter 201 and the second smoothing filter 202 becomes a mountain shape. Furthermore, the graph of the first smoothing filter 201 becomes a shape with a peak value higher than that of the graph of the second smoothing filter 202.

Successively, in the image inspecting processing, difference data are calculated from image data after the smoothing processing by the two kinds of smoothing filters. The difference data are values acquired by subtracting the gradation value of each pixel after the smoothing processing by the second smoothing filter 202 from the gradation value of each pixel after the smoothing processing by the first smoothing filter 201. The difference data are acquired for both the read image data and the original image data.

In the image inspecting processing, an abnormal candidate is extracted by comparing the difference data after the smoothing processing to the read image data with the difference data after the smoothing processing to the original image data.

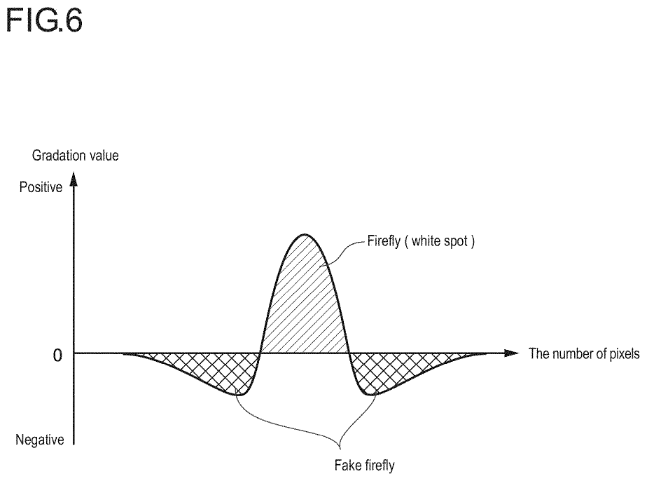

FIG. 6 is a graph showing difference data after the smoothing processing for read image data having a firefly by the first smoothing filter 201 and the second smoothing filter 202. In FIG. 6, the horizontal axis indicate pixels corresponding to the horizontal axis of FIG. 5, and the vertical axis indicates gradation value. Hereinafter, the difference data after the smoothing processing for the read image data is referred to as the difference data of the read image data, and the difference data after the smoothing processing for original image data is referred to as the difference data of the original image data.

As shown in FIG. 6, in the graph of the difference data of the read image data, a mountain-shaped portion is observed at almost the center where there is a firefly. Moreover, in the graph of the difference data of the read image data, a valley-shaped portion is also observed in the portion of the skirt of the mountain-shaped portion of the graph. The valley-shaped portion has a value lower that the differential value “0”. This valley-shaped portion is referred to as a fake firefly.

On the other hand, in the original image data, there is no abnormality like a firefly. Although not shown in the drawings, for this reason, the graph of the difference data of the original image data does not become a mountain shape. Therefore, as a result of comparing the difference data of the original image data with the difference data of the read image data as shown in FIG. 6, if a graphical shape that does not exist in the difference data of the original image data, exists in the difference data of the read image data, a plurality of pixels in the portion in the graphical shape is extracted as an abnormal candidate.

In an image evaluating method that does not apply the present embodiment, there is a method of determining that a pixel having a different gradation value has an abnormality, by comparing the gradation value of each pixel in the difference data of original image data with the gradation value of each pixel in the difference data of read image data. In such the image evaluating method that does not apply the present embodiment, a portion of a firefly in FIG. 6 is determined as having abnormalities. Furthermore, in the image evaluating method that does not apply the present embodiment, portions of fake fireflies in FIG. 6 are also determined as having abnormalities. The determining such the fake fireflies as abnormal is erroneous detection. In the case where the gradation value of a firefly itself is low, since the gradation value of a fake firefly is also low, there is a possibility that the erroneous detection is avoided by using a threshold. However, in the case where the gradation value of a firefly itself is high, the gradation value of a fake firefly also becomes high. For this reason, even if a low value of a gradation value is made not to be erroneously detected by a threshold, if the gradation value of the fake firefly itself becomes high, erroneous detection cannot be prevented.

Then, in the present embodiment, in order to suppress or prevent the erroneous detection of a fake firefly, fake firefly eliminating processing is being performed.

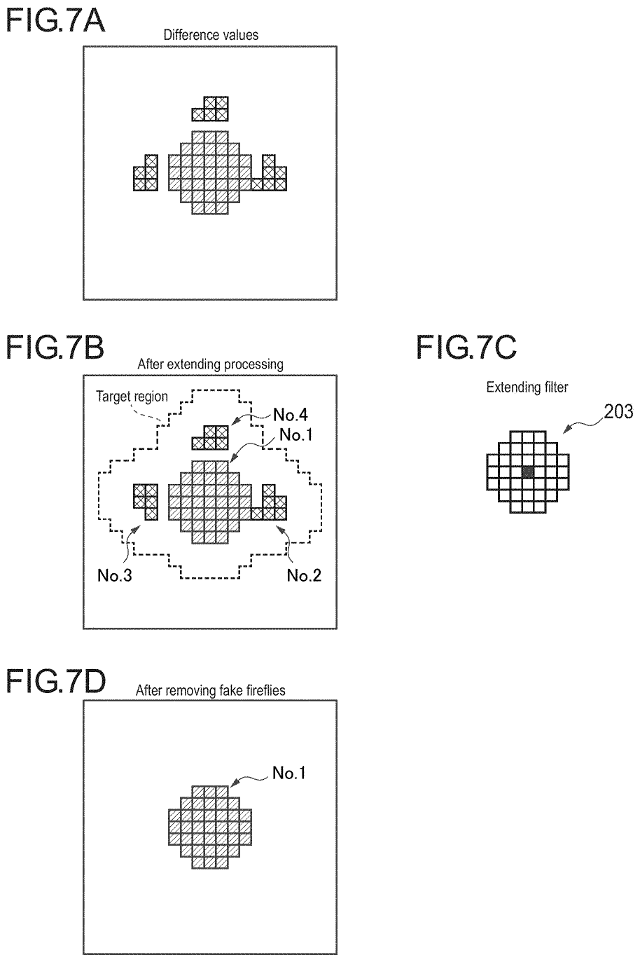

FIGS. 7A to 7D are plan view for describing a pixel in which there is a firefly and its peripheral pixels, FIG. 7A shows a state of difference values after smoothing filter processing, FIG. 7B shows a state after extending processing, FIG. 7C shows an example of an extending filter, and FIG. 7D shows a state after removing fake fireflies.

FIG. 7A shows pixels each of which has a gradation value other than zero as a difference value after processing by the above-mentioned two kinds of large and small smoothing filters. In FIG. 7A, ranges in each of which pixels with a gradation value other than zero and with the same sign are continued, are extracted as respective lumps of abnormal candidates No. 1 to No. 4. The abnormal candidate No. 1 has a positive sign and corresponds to the position of a firefly in FIG. 6. The abnormal candidates No. 2 to No. 4 have a negative sign and correspond to the respective positions of the false fireflies in FIG. 6.

Successively, in the fake firefly eliminating processing, the regions containing a plurality of abnormal candidates are extended. In the extending processing, each of the pixels in each of the abnormal candidates is applied with the extending filter 203 and extended to a range of pixels contained in the extending filter 203. With this, the multiple abnormal candidates are collected and are made to a target region. The extending filter 203 is a circular filter that makes a plurality of pixels a range, as shown in FIG. 7C. A region after extending becomes the target region for detecting abnormalities. In the application of the extending filter 203, the center pixel (black pixel portion in FIG. 7C) of the extending filter 203 is disposed at each pixel (target pixel) in the abnormal candidates No. 1 to No. 4, and a range included in the extending filter 203 is made a target region (refer to FIG. 7B).

Then, in the fake firefly eliminating processing, only one abnormal candidate having a pixel with the highest gradation value in the target region is selected, and it is determined that there is a firefly (being abnormal).

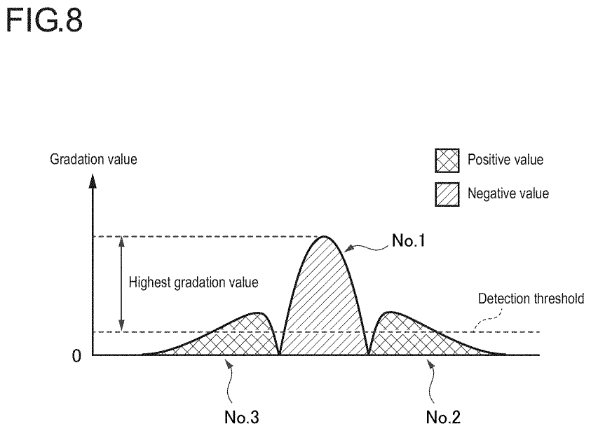

FIG. 8 is a graph in which the gradation value of each pixel is made an absolute value. As shown in FIG. 8, by making the gradation value of each pixel an absolute value, comparison becomes easy. Moreover, in the present embodiment, there is provided a detection threshold for determining abnormality. The detection threshold is provided for not detecting a too small change of a gradation value as abnormalities. As the detection threshold, for example, a gradation value that cannot be detected as abnormalities, such as a firefly (not a fake firefly) by experience or by visual inspection, may be set.

In FIG. 8, in the abnormal candidate No. 1, there is a pixel that has the highest gradation value. Therefore, one lump of the abnormal candidate No. 1 is detected as an abnormal part of a firefly. FIG. 7D shows a state where only the abnormal candidate No. 1 has been detected as a firefly.

Next, the procedures of the image inspecting processing by the image inspecting apparatus 20 is described.

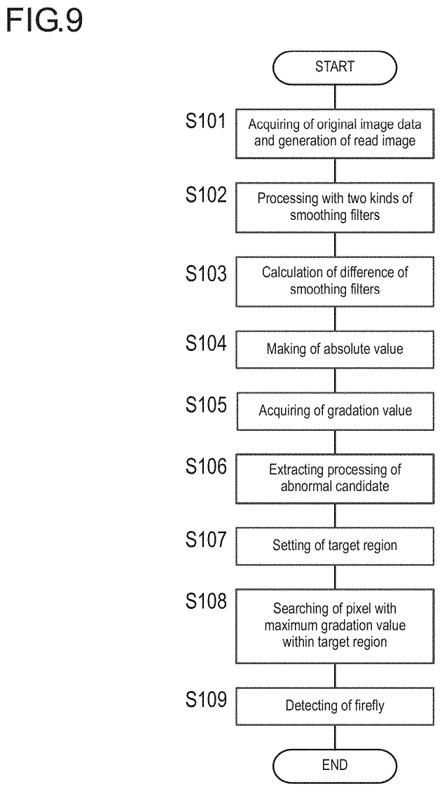

FIG. 9 is a flowchart showing the procedures of the image inspecting processing by an inspecting apparatus.

The processor 21 acquires original image data through the communicator 29 and, in addition, generates read image data by making the reader 23 read a sheet 90 (S101). The original image data and the read image data are linked as a pair of image data and memorized in the memory 22.

Successively, the processor 21 performs the smoothing processing with the first smoothing filter 201 and the second smoothing filter 202 for each of the original image data and the read image data (S102).

Then, the processor 21 calculates difference data of each of the original image data and the read image data after the smoothing processing (S103).

Successively, the processor 21 makes the difference data (difference value) into the absolute value (S104). In this connection, the processing of making into the absolute value may be performed at any stage in conformity with processing content as long as before performing the next maximum gradation value search (S108).

Then, the processor 21 acquires the gradation value of each pixel of the difference data (S105).

Successively, the processor 21 compares the difference data of the read image data with the difference data of the original image data and extracts pixels with gradation values different more than a threshold for as an abnormal candidate of a lump each same sign (S106).

Then, the processor 21 extends a range including an abnormal candidate by the extending filter 203 and sets a target region (S107).

Then, the processor 21 searches a pixel of the maximum gradation value from the target region (S108).

Subsequently, the processor 21 detects one abnormal candidate containing the pixel of the maximum gradation value as a firefly (S109). With the above description, the image inspecting processing is ended.

As explained in the above, in the present embodiment, from a target region including an abnormal candidate with a true firefly and an abnormal candidate with a fake firefly, one abnormal candidate containing a pixel with the highest gradation value is determined as having a firefly, whereby it is possible to prevent detecting a fake firefly as abnormalities. Therefore, according to the present embodiment, the inspection or detection accuracy of an image abnormality can be improved.

### Modified Example

In the above-mentioned present embodiment, one abnormal candidate is detected as an abnormality (firefly) on the basis of the gradation value of each pixel in each abnormal candidate included in a target region. However, a method for detecting one abnormal candidate as an abnormality (firefly) by removing a fake firefly from a plurality of abnormal candidates included in a target region, is not limited to this. Hereinafter, other methods for detecting one abnormal candidate as an abnormality (firefly) are described as modified examples. In this connection, even in other methods, the procedures up to the setting of a target region are the same as the image inspecting processing in the above-mentioned embodiment.

### Modified Example 1

In the modified example 1, one abnormal candidate is detected as an abnormality on a basis of the sign of the gradation value of each pixel in each abnormal candidate included in a target region. As can be understood from the already-explained FIG. 7, a fake firefly (No. 2 to 4) becomes to have negative values in difference data. Accordingly, in the modified example 1, by inspecting for each of the abnormal candidates in a target region, then, as result of the inspection, one abnormal candidate in which the sign of pixels becomes positive, is detected as a firefly. In the modified example 1, since the detection is performed by only inspecting the sign of an abnormal candidate, the detection of an image abnormality can be performed easily. Moreover, also in the modified example 1, a fake firefly can be removed, and the accuracy of abnormality detection can be improved.

### Modified Example 2

The modified example 2 detects one abnormal candidate as an abnormality on the basis of the number of pixels in each of abnormal candidates included in a target region. As can be seen from the already-explained FIG. 7, as compared with a true firefly (No. 1), in each of fake fireflies (Nos. 2 to 4), the number of pixels in an abnormal candidate becoming a lump is small. Then, in the modified example 2, from abnormal candidates included in a target region, one abnormal candidate with the largest number of pixels is detected as a firefly. In the modified example 2, since the detection is performed by only counting the number of pixels in an abnormal candidate, the detection of an image abnormality can be performed easily. Furthermore, also in the modified example 2, a fake firefly can be removed, and the accuracy of abnormality detection can be improved.

### Modified Example 3

The modified example 3 detects one abnormal candidate as an abnormality on the basis of an integrated value of a gradation value of each pixel and the number of pixels in each abnormal candidate included in a target region. As can be seen from the already-explained FIGS. 6 and 7, as compared with a true firefly (No. 1), in each of fake fireflies (Nos. 2 to 4), the gradation value and the number of pixels in an abnormal candidate becoming a lump are different. Then, in the modified example 3, for each abnormal candidates included in a target region, the gradation value of each pixel and the number of pixels are integrated (the gradation values of included pixels are integrated by the number of pixels), and then, one abnormal candidate with the highest integrated-value is detected as a firefly. In the modified example 3, since the gradation values of pixels and the number of pixels of an abnormal candidate are used, it is possible to improve the detection accuracy of image abnormalities. Of course, also in the modified example 3, a fake firefly can be removed, and the accuracy of abnormality detection can be improved.

### Modified Example 4

The modified example 4 detects one abnormal candidate as an abnormality on the basis of a position of each abnormal candidate included in the above-mentioned target region. As can be seen from the already-explained FIG. 6 and FIG. 7, fake fireflies (Nos. 2 to 4) occur in the periphery of a true firefly (No. 1). Then, in the modified example 4, by comparing a positional relationship with other abnormal candidates for each abnormal candidate included in a target region, one abnormal candidate positioned between an abnormal candidate and other abnormal candidate is detected as a firefly. In the modified example 4, by using the positions of pixels of an abnormal candidate, it is possible to remove a fake firefly and to improve the accuracy of abnormality detection.

Furthermore, as the image inspecting processing, the above-mentioned embodiment and the modified examples may be combined appropriately.

As mentioned in the above, although the embodiments of the present disclosure have been described, various modified examples are possible. In the above-mentioned embodiment and modified examples, although an abnormality to be detected has been described on the basis of an example of a firefly, abnormalities capable of being detected by the present disclosure are not limited to the firefly. As the abnormalities capable of being detected by the present disclosure, for example, streaky scratches and the like that appear as lines with high gradation values relative to peripheral pixels, can be detected. In the case where difference data by two kinds of smoothing filters are taken from streaky scratches similarly to fireflies, there may be a case where false streaky scratches appear around a true streaky scratch. By applying the present disclosure, it is possible to remove such false streaky scratches and to improve the detection accuracy of streaky scratches.

Moreover, as the embodiment and modified example of the present disclosure, it is possible to improve detection accuracies for spot-shaped abnormalities and streaky scratches that do not exist in original image data and become high density than peripheral pixels. In the spot-shaped abnormalities and streaky scratches that become high density than peripheral pixels, their gradation values become lower than the peripheral pixels. In the case of such abnormalities, within the read image data, the gradation value becomes lower in the abnormal portions. Therefore, in the case of such abnormalities, similarly to the embodiment and the modified example, in a graph where peripheral pixels (background) are set to 0, the gradation value becomes a shape (a valley shape) that protrudes in the direction of the sign of −(minus). Moreover, even in such abnormalities, in a graph of difference data after the smoothing processing, small mountain shapes (a sign is +) becoming a fake abnormality appear in the vicinity of a large valley shape being a true abnormality. In such a graphical shape, the respective signs of the portions of an abnormality and a fake abnormality are merely reversed relative to the white-void abnormalities described in the embodiment. For this reason, for the abnormalities in which the gradation values is lower than peripheral pixels, with the processing similar to the processing in the above-mentioned embodiment and modified example, it is possible to detect only a true abnormality. Moreover, in the embodiment, since the value of difference data is made into the absolute value in the middle of processing, it is possible to perform processing without considering differences in sign in abnormal portions.

In addition, conditions, numerical values, etc. used in the description of the embodiment are prepared only for description. Accordingly, the present disclosure is not limited to these conditions and numerical values.

Moreover, on the basis of the configuration described in the scope of claims, various modifications are possible for the present disclosure. However, such the various modifications are included in the scope of the present disclosure.

Although embodiments of the present disclosure have been described and illustrated in detail, the disclosed embodiments are made for purpose of illustration and example only and not limitation. The scope of the present disclosure should be interpreted by terms of the appended claims.

As used herein, the words “can” and “may” are used in a permissive (i.e., meaning having the potential to), rather than mandatory sense (i.e., meaning must). The words “include,” “includes,” “including,” and the like mean including, but not limited to. Similarly, the singular form of “a” and “the” include plural references unless the context clearly dictates otherwise. And the term “number” shall mean one or an integer greater than one (i.e., a plurality).

What is claimed is:

1. An image inspecting apparatus, comprising:
a calculator that calculates difference data of each image data obtained by performing smoothing processing for image data with multiple smoothing filters different in range;
an extractor that extracts multiple abnormal candidates based on the difference data; and
a detector that (i) makes a range in which the extracted multiple abnormal candidates are collected, into a target region, and (ii) detects one abnormal candidate as an abnormality from the multiple abnormal candidates included in the target region based on the difference data.

2. The image inspecting apparatus according to claim 1, wherein the image data include original image data contained in a print job and read image data obtained by reading an image formed on a recording material based on the original image data, and
wherein the extractor extracts the abnormal candidates based on the difference data of the original image data and the difference data of the read image data.

3. The image inspecting apparatus according to claim 1, wherein the smoothing filter includes a first smoothing filter that smooths a range of a first region and a second smoothing filter that smooths a range of a second region wider than the first region, and
wherein the calculator calculates the difference data between the image data subjected to the smoothing processing by the first smoothing filter and the image data subjected to the smoothing processing by the second smoothing filter.

4. The image inspecting apparatus according to claim 1, wherein the detector detects one abnormal candidate as an abnormality based on a gradation value of each pixel in each abnormal candidate included in the target region.

5. The image inspecting apparatus according to claim 1, wherein the detector detects one abnormal candidate as an abnormality based on a sign of a gradation value of each pixel in each abnormal candidate included in the target region.

6. The image inspecting apparatus according to claim 1, wherein the detector detects one abnormal candidate as an abnormality based on a number of pixels in each abnormal candidate included in the target region.

7. The image inspecting apparatus according to claim 1, wherein the detector detects one abnormal candidate as an abnormality based on an integrated value of a number of pixels and a gradation value of each pixel in each abnormal candidate included in the target region.

8. The image inspecting apparatus according to claim 1, wherein the detector detects one abnormal candidate as an abnormality based on a position of each abnormal candidate included in the target region.

9. The image inspecting apparatus according to claim 1, wherein the detector collects the multiple abnormal candidates with processing of a circular filter relative to a target pixel and forms the target region.

10. The image inspecting apparatus according to claim 1, wherein the abnormality is a pixel in a color image in which a gradation value of the pixel is nearly whiter than a gradation value of the color image.

11. An image inspecting method, comprising:
(a) calculating difference data of each image data obtained by performing smoothing processing for image data with multiple smoothing filters different in range;
(b) extracting multiple abnormal candidates based on the difference data; and
(c) making a range in which the extracted multiple abnormal candidates are collected, into a target region, and detecting one abnormal candidate as an abnormality from the multiple abnormal candidates included in the target region based on the difference data.

12. The image inspecting method according to claim 11, wherein the image data include original image data contained in a print job and read image data obtained by reading an image formed on a recording material based on the original image data, and
wherein, in (b), the abnormal candidates are extracted based on the difference data of the original image data and the difference data of the read image data, obtained in (a).

13. The image inspecting method according to claim 11, wherein the smoothing filter includes a first smoothing filter that smooths a range of a first region and a second smoothing filter that smooths a range of a second region wider than the first region, and
wherein, in (a), the difference data between the image data subjected to the smoothing processing by the first smoothing filter and the image data subjected to the smoothing processing by the second smoothing filter, is calculated.

14. The image inspecting method according to claim 11, wherein, in (c), one abnormal candidate is detected as an abnormality based on a gradation value of each pixel in each abnormal candidate included in the target region.

15. The image inspecting method according to claim 11, wherein, in (c), one abnormal candidate is detected as an abnormality based on a sign of a gradation value of each pixel in each abnormal candidate included in the target region.

16. The image inspecting method according to claim 11, wherein, in (c), one abnormal candidate is detected as an abnormality based on a number of pixels in each abnormal candidate included in the target region.

17. The image inspecting method according to claim 11, wherein, in (c), one abnormal candidate is detected as an abnormality based on an integrated value of a number of pixels and a gradation value of each pixel in each abnormal candidate included in the target region.

18. The image inspecting method according to claim 11, wherein, in (c), one abnormal candidate is detected as an abnormality based on a position of each abnormal candidate included in the target region.

19. The image inspecting method according to claim 11, wherein, in (c), the multiple abnormal candidates are collected with processing of a circular filter relative to a target pixel and are made into the target region.

20. The image inspecting method according to claim 11, wherein the abnormality is a pixel in a color image in which a gradation value of the pixel is nearly whiter than a gradation value of the color image.

21. A non-transitory, computer-readable medium storing instructions for making a computer execute the image inspecting method according to claim 11.
